(19) United States
(12) Patent Application Publication
(10) Pub. No.: US 2026/0316369 A1
(43) Pub. Date: Oct. 15, 2026

(54) Nozzle for forming containers from thermoplastic material

(71) Applicant: SIDEL PARTICIPATIONS, Octeville-sur-Mer (FR)

(72) Inventors: Cedric LEMAIRE, OCTEVILLE-SUR-MER (FR); Guillaume GIRODIT, OCTEVILLE-SUR-MER (FR)

(21) Appl. No.: 19/647,990

(22) Filed: Apr. 15, 2026

(30) Foreign Application Priority Data
Apr. 15, 2025 (FR) 2504031

(51) Int. Cl. B29C 49/58; B29C 49/42

(52) U.S. Cl. CPC B29C 49/58; B29C 2049/4294; B29C 2049/5896

(57) ABSTRACT

A nozzle for forming containers from thermoplastic material by injecting a pressurized fluid into a preform is provided. The nozzle comprises a support equipped with a pressurized fluid intake pipe, a tubular nozzle end-piece separate from the support that is intended to be mounted on the support to extend the intake pipe and that comprises a blowing seal for sealingly connecting a free end of the nozzle end-piece to a preform, and an attachment member for removably attaching the end-piece to the support. The attachment member comprises a clamping collar.

### CROSS-REFERENCE TO RELATED APPLICATIONS

This application claims priority to French Patent Application No. FR2313893, filed December 11, 2023, the entire contents of which are incorporated herein by reference.

### FIELD OF INVENTION

The present disclosure relates to nozzles for forming containers from thermoplastic material by injecting a pressurized fluid into a preform, and more particularly to a nozzle comprising a support equipped with a pressurized fluid intake pipe; a tubular nozzle end-piece, separate from the support, which is intended to be mounted on the support to extend the intake pipe and which comprises a blowing seal for sealingly connecting its free end to a preform; and an attachment member for removably attaching the end-piece to the support.

### BACKGROUND

It is known practice to produce containers made of thermoplastic material, such as polyethylene terephthalate (PET), by stretch blow molding of preforms in a forming unit.

In general, a preform has an axisymmetric shape. The preform comprises a neck which already has its definitive shape, whereas a body of the preform is intended to be deformed during the forming method. The main axis of the preform passes through the center of the neck.

To enable its deformation, the body of the preform is heated to above a glass transition temperature making it possible for the wall of the body to be made malleable by substantially reducing its elastic limit. By contrast, the neck is kept at a temperature lower than the glass transition temperature in order to avoid deformation thereof.

In order to produce containers having a substantially constant wall thickness, it is known practice to carry out what is referred to as biaxial stretching of the material constituting the wall of the preform in order to deform it plastically. To this end, the forming method comprises a first pre-blowing step during which forming fluid is injected at a pre-blowing pressure. During this pre-blowing step, a sliding stretching rod is introduced coaxially into the neck of the preform, pushing the bottom of the preform so as to stretch the wall of the body in an axial direction.

At the end of this pre-blowing step, a blowing step is triggered, during which a compressed forming fluid is injected at a blowing pressure, above the pre-blowing pressure, into the body of the preform in such a way as to allow stretching of the material of the wall of the body, distributed correctly in a generally circumferential direction.

In general, this forming method is carried out in a cavity of a mold that has an impression conforming to the final container to be obtained. During the blowing step, the wall of the body of the preform is pressed against the wall of the impression under the effect of the pressure of the forming fluid in order to give the container its definitive shape.

When it starts to deform, the preform becomes an "intermediate container" before reaching its definitive "final container" shape.

In the remainder of the description and in the claims, the term "hollow body" will be used to denote either a preform, an intermediate container or a finished container.

As the neck of a preform already has its definitive shape, it is essential that this neck be integrally preserved during the forming operation.

Moreover, facilities for manufacturing containers from thermoplastic material are designed in such a way as to be able to manufacture containers of various shapes and sizes. Thus, the same facility is liable to process preforms having necks of various formats.

To ensure efficient blowing, with no loss of energy, and without damaging the neck of each hollow body, it is necessary to change some of the elements of the nozzle, usually referred to as "customization elements". These elements have dimensions adapted to each neck format. The customization elements of the nozzle are included in a nozzle end-piece adapted to the format of the preform to be processed. The nozzle end-piece is mounted on a support which stays the same for all preform formats.

The nozzle end-piece generally takes the form of a housing which is mounted on the support via attachment means.

The nozzle end-piece is generally attached to the support by screwing using screws oriented axially. However, such an attachment means does not make it possible to change the end-piece quickly. Furthermore, it is necessary to comply with the tightening torques for each screw in order to ensure good sealing.

It has also been proposed to attach the end-piece to the support using a ball attachment. However, such an attachment mechanism requires very precise machining of the various parts in order to ensure that there are no clearances that could give rise to leaks.

Such an arrangement is therefore very complex and expensive to manufacture.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

In a first aspect, a nozzle for forming containers from thermoplastic material by injecting a pressurized fluid into a preform is provided. The nozzle comprises: a support equipped with a pressurized fluid intake pipe; a tubular nozzle end-piece, separate from the support, which is intended to be mounted on the support to extend the intake pipe and which comprises a blowing seal for sealingly connecting its free end to a preform; an attachment member for removably attaching the end-piece to the support; wherein the attachment member comprises a clamping collar.

The use of a clamping collar as the attachment member allows for rapid and secure attachment of the end-piece to the support, enabling quick replacement of the end-piece when processing preforms of different formats while ensuring reliable sealing under high pressure conditions.

The nozzle end-piece may comprise a first annular flange and the support may comprise a second annular flange, a bearing face of which is intended to come into axial abutment against a facing bearing face of the first annular flange when the nozzle end-piece is mounted on the support, the clamping collar clamping edges of the two flanges.

The arrangement of annular flanges with bearing faces in axial abutment provides a stable and aligned connection between the end-piece and the support, while the clamping collar securely holds the flange edges together.

The clamping collar may comprise an inner groove for receiving the assembled flanges.

The inner groove facilitates proper positioning and retention of the assembled flanges within the clamping collar, ensuring consistent alignment during clamping.

Each flange may comprise a support face opposite its bearing face, the support face having a frustoconical shape interacting with an inclined side wall of the groove in order to axially compress the two bearing faces against one another when the collar is clamped radially around the flanges.

The frustoconical support faces interacting with inclined side walls of the groove convert radial clamping force into axial compression, ensuring tight sealing between the bearing faces without requiring complex machining or precise tolerances.

A resilient annular pressure-responsive gasket may be interposed between the two bearing faces.

The pressure-responsive gasket provides enhanced sealing between the bearing faces and helps distribute the clamping force evenly around the circumference of the flanges.

The pressure-responsive gasket may be received in an annular slot in at least one of the two bearing faces.

Receiving the gasket in an annular slot ensures proper positioning of the gasket and prevents displacement during assembly and operation.

The support may have a centering sleeve which extends axially protruding from the bearing face of the second flange, the centering sleeve being fitted axially in a central passage in the end-piece during mounting.

The centering sleeve facilitates accurate alignment and centering of the end-piece relative to the support during mounting, simplifying the assembly process.

A free end of the centering sleeve may be received in axial abutment against an internal shoulder of the end-piece.

The axial abutment between the centering sleeve and the internal shoulder provides a defined axial positioning of the end-piece relative to the support.

An annular sealing gasket may be interposed between the shoulder and the free end of the sleeve when the end-piece is mounted on the support.

The sealing gasket between the shoulder and the sleeve prevents escape of the pressurized blowing fluid, ensuring efficient forming operations.

The clamping collar may comprise at least two jaws clamped against one another by at least one closure member.

The use of jaws with a closure member allows for easy opening and closing of the clamping collar, facilitating rapid attachment and detachment of the end-piece.

The jaws may be articulated to one another by a hinge arranged at a first end of the jaws, the closure member being arranged at the other end of the jaws.

The hinged arrangement of the jaws allows the collar to be opened and closed in a single motion while maintaining the jaws as a unified assembly.

The at least one closure member may comprise a pulling rod which is received in openings at the free ends of the jaws to pull the jaws toward one another.

The pulling rod provides a simple and effective mechanism for drawing the jaws together to achieve the desired clamping force.

The attachment member may comprise a cam lever which pulls the rod when it is folded down against the jaw.

The cam lever enables rapid actuation of the closure member, allowing the clamping collar to be secured or released quickly without the need for tools.

In a second aspect, a nozzle end-piece having a main axis, for a nozzle for forming containers from thermoplastic material, is provided. The nozzle end-piece comprises: a blowing seal for sealingly connecting its free end to a preform; a first annular flange arranged at an upper end of the end-piece and having a bearing face and an opposite support face, the support face having a frustoconical shape whereas the bearing face is orthogonal to the axis.

The frustoconical support face and orthogonal bearing face of the first annular flange enable the end-piece to be securely clamped to a support using a clamping collar while ensuring proper axial compression and sealing.

The nozzle end-piece may further comprise a stabilizer intended to bear on a rim of the preform to prevent the preform from moving inside a mold.

The stabilizer helps maintain the preform in a stable position during the forming operation, preventing misalignment that could result in defective containers.

The nozzle end-piece may further comprise an internal shoulder configured to receive a free end of a centering sleeve in axial abutment.

The internal shoulder provides a defined contact surface for the centering sleeve, ensuring accurate axial positioning of the end-piece relative to the support.

In a third aspect, a nozzle support having a main axis, for a nozzle for forming containers from thermoplastic material, is provided. The nozzle support comprises: a second annular flange having a bearing face and an opposite support face, the support face having a frustoconical shape whereas the bearing face is orthogonal to the axis; a centering sleeve which extends axially protruding from the bearing face of the second flange.

The frustoconical support face and orthogonal bearing face of the second annular flange, combined with the centering sleeve, enable the support to receive and accurately position a nozzle end-piece while facilitating secure clamping and proper sealing.

The nozzle support may further comprise a pressurized fluid intake pipe which passes through a body of the support axially.

The intake pipe provides a pathway for the pressurized forming fluid to reach the preform through the nozzle assembly.

The second annular flange may have an outside diameter configured to align with a peripheral edge of a first annular flange of a nozzle end-piece when the end-piece is mounted on the support.

The aligned outside diameters of the flanges ensure proper engagement with the clamping collar and uniform distribution of clamping force.

The centering sleeve may be configured to be received with a radial clearance in a central passage of a nozzle end-piece to allow sliding while ensuring centering.

The radial clearance allows for easy assembly while the close fit ensures accurate centering of the end-piece on the support.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

Further features and advantages of the invention will become apparent on reading the following detailed description, which will be more clearly understood with reference to the appended drawings, in which:

FIG. 1 is a view in axial section schematically showing a forming station provided with a nozzle.

FIG. 2 is a perspective view showing a nozzle produced according to the teachings of the invention fitted to the station in FIG. 1 and comprising an end-piece and a support, the end-piece being detached from its support.

FIG. 3 is a view in axial section of FIG. 2.

FIG. 4 is a perspective view showing the end-piece in FIG. 2 positioned on its support.

FIG. 5 is a view in axial section of FIG. 4.

FIG. 6 is a perspective view showing the end-piece in FIG. 4 attached to its support by means of a clamping collar.

FIG. 7 is a view in axial section of FIG. 6.

FIG. 8 is a view of the clamping collar in FIG. 6 in perspective with an axial section.

FIG. 9 is a perspective view of the clamping collar in FIG. 6 in the closed position.

FIG. 10 is a view similar to that in FIG. 9 from another viewing angle.

FIG. 11 is a perspective view showing the clamping collar in FIG. 6 with a cam lever in the open position.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

In the description below, elements with an identical structure or similar functions are denoted by the same reference sign.

The remainder of the description will adopt an axial orientation parallel to an axis of a nozzle and directed from bottom to top, this not being limiting. In the example depicted in the figures, the axial direction corresponds, non-limitingly, to the direction of gravity.

Also defined are radial directions orthogonal to the axis of the nozzle and directed outward from the axis of the nozzle.

Also defined are tangential directions, each of which is orthogonal to the axial direction and to an associated radial direction.

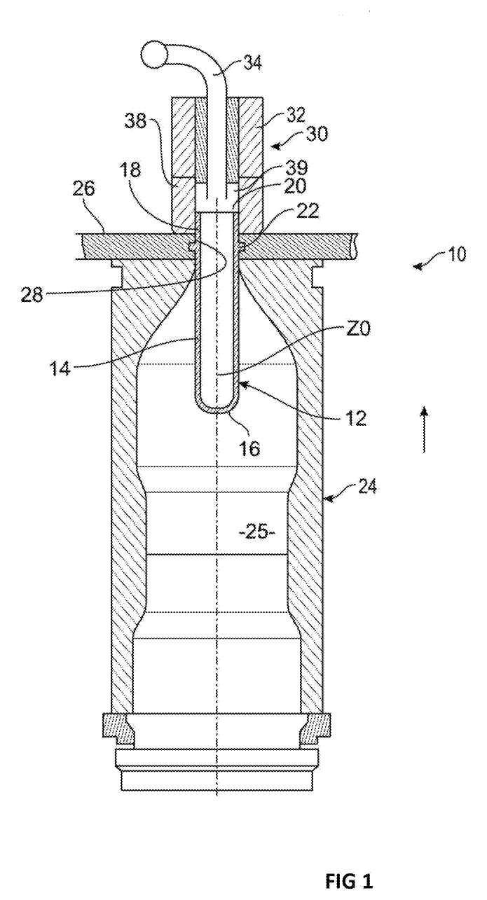

FIG. 1 depicts a forming station for forming a container by stretch blow molding or blow molding of a preform.

Such a forming station is for example mounted on a rotary carousel of a forming unit (not shown). The forming unit forms part of a facility (not shown) for manufacturing containers. The facility comprises for example a thermal conditioning unit arranged upstream of the forming unit in the direction of movement of the preforms.

As shown in FIG. 1, the preform has a shape which is substantially axisymmetric about a main axis of vertical orientation. It has a cylindrical body with a tubular wall, said body being closed at its lower end by a bottom and being extended at its upper end by a neck which is open axially toward the top, and which is also tubular. The neck is delimited at the top by a circular edge of an upper end, which will be referred to below as the "rim". The neck of the preform also comprises an annular ring which protrudes radially. The ring is in this case arranged at the junction between the base of the neck and the body.

Such a preform is made of thermoplastic material, in this case polyethylene terephthalate (PET). It is conventionally obtained by injection molding.

The neck is generally injection-molded in such a way as to already have its definitive shape, whereas the body of the preform is intended to be subjected to a relatively significant deformation to form the final container during a subsequent forming step.

To this end, before being received in the blowing station, the body of the preform is heated, for example in a thermal conditioning unit, to above a glass transition temperature in such a way as to make its walls malleable, whereas the neck is kept at a temperature substantially colder than the glass transition temperature.

The forming station comprises a mold having a molding cavity. The body of the preform thus heated is received in the molding cavity. The mold comprises a horizontal upper face. The mold comprises, on its upper face, an opening for the neck to pass through. The ring rests on the upper face of the mold such that the neck protrudes vertically above the upper face of the mold.

The mold is generally made in two half-molds assembled along a vertical joining plane passing through the opening through which the neck passes. This configuration makes it possible to eject the final container by separating the two half-molds at the end of the forming operation.

The forming station also comprises a nozzle for forming containers from thermoplastic material by injecting a pressurized fluid into a preform.

The forming fluid is in this case a gas, for example compressed air at 40 bar.

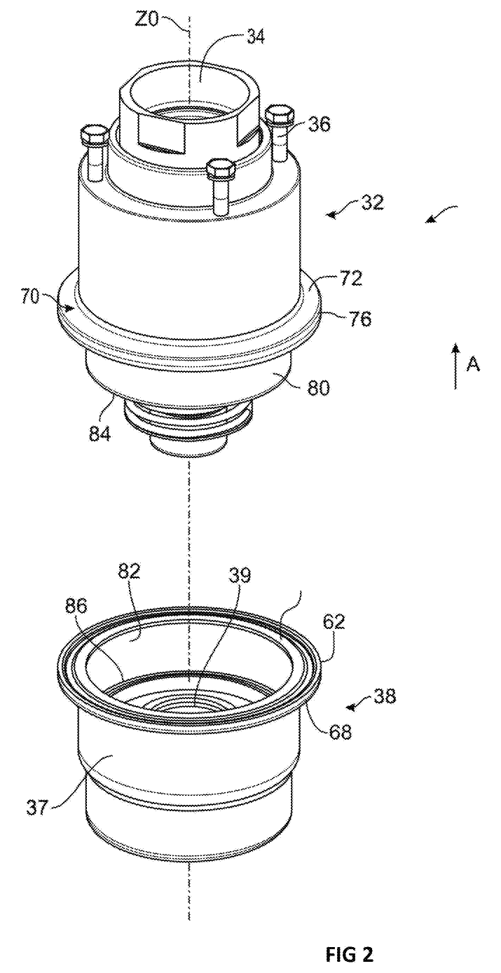

The nozzle is shown very schematically in FIG. 1. The rest of the description will refer to FIGS. 2 to 7, which show the nozzle in more detail.

The nozzle comprises a support. The support comprises a generally tubular body of axis. The support is equipped with a pressurized fluid intake pipe which passes through the body axially.

The support is intended to be permanently attached to a carriage (not shown) sliding in an axial direction relative to the mold. The support is intended to stay the same regardless of the dimensions of the preforms processed. The support is for example securely attached by means of screws. Although the support can be removed for maintenance purposes, this is not intended to be carried out often and it requires a great deal of time and tools. It is in particular necessary to screw the screws in a certain order with a predetermined torque in order to guarantee good sealing of the nozzle, in particular with respect to the very high pressure of the blowing fluid, which can reach around 40 bar.

The nozzle also comprises a tubular nozzle end-piece, which is separate from the support. The nozzle end-piece is intended to be mounted on the support. The nozzle end-piece comprises a body which has a tubular shape of axis and which extends between an upper end for connection to the support and a free lower end. A central opening in the end-piece passes axially through the body. Thus, the central opening axially extends the intake pipe when it is mounted on the support.

The nozzle end piece comprises a blowing seal for sealed connection of its free end to a preform.

The blowing seal forms an element referred to as a "customization element" which must be adapted to the dimensions of the preform present in the mold, in particular the diameter of the neck.

The end-piece is intended to be replaced fairly frequently, each time a new batch of preforms with different dimensions to the previous batch is processed by the facility. This makes it possible in particular to adapt the dimensions of the end-piece itself and the dimensions of the customization elements, in particular the blowing seal, to the dimensions of the new preforms.

By way of non-limiting example, in this case there is a nozzle referred to as a "bell nozzle" in which the blowing seal is arranged at the free lower end of the end-piece to come into contact with the upper face of the mold when the nozzle is in an active blowing position. Thus, the protruding part of the neck of the preform is received in the central opening.

In a variant of the invention that has not been shown, the blowing seal is arranged in such a way as to be in sealed contact directly with a part of the preform, for example the rim or the ring.

By way of non-limiting example, the end-piece may also comprise other customization elements, in addition to the blowing seal. For example, the end-piece in this case comprises a stabilizer which is intended to bear on the rim of the preform in order to prevent the preform from moving inside the mold. The stabilizer is a tubular element which is urged elastically toward the preform by an elastic member, in this case a spring. The elastic member is preferably arranged permanently in the support because it does not need to be changed each time there is a change of format.

The nozzle also comprises an attachment member for removably attaching the end-piece to the support.

This is a rapid attachment member which makes it possible to detach the end-piece so as to quickly replace it with another.

"Rapid attachment" refers to an attachment member allowing attachment much more rapidly than with screws which require, as mentioned above, very strict tightening guidelines to be followed.

According to the teachings of the invention, the attachment member comprises a clamping collar. This is more particularly a collar which is clamped radially.

The clamping collar comprises at least two jaws, in this case two jaws, and at least one closure member for closing the jaws in the position in which they are clamped against one another.

Each jaw in this case has the shape of a half-ring.

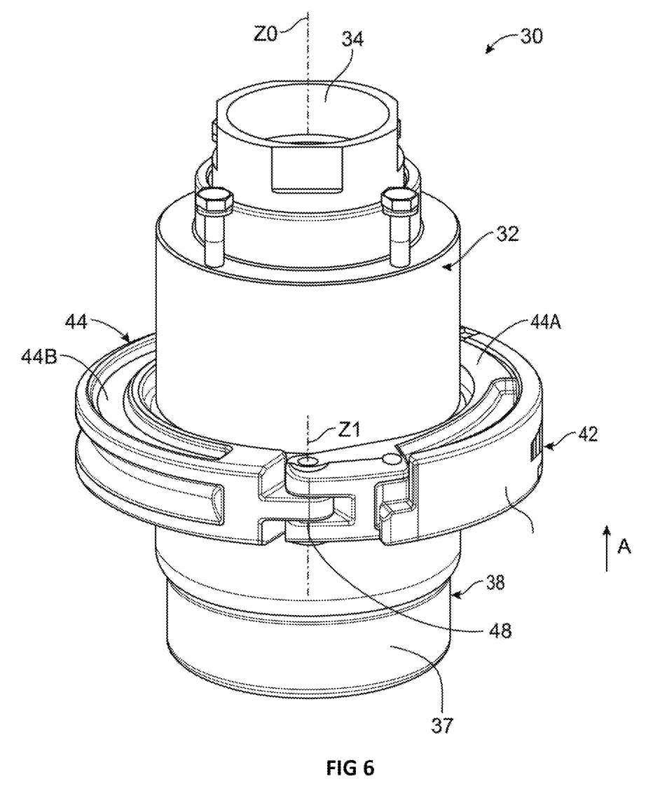

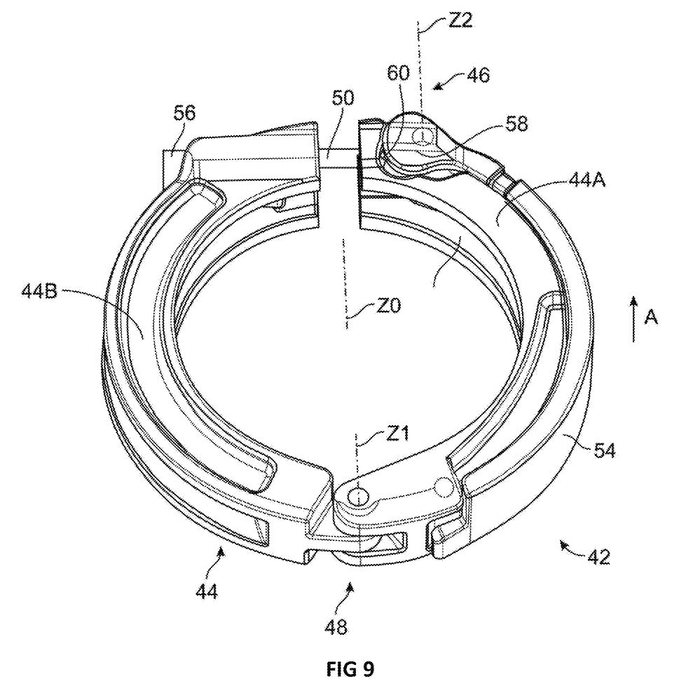

As shown in FIGS. 6 to 10, the attachment member is in this case, by way of non-limiting example, a clamping collar referred to as a "tri clamp". To this end, the two jaws are mounted articulated to one another about an axially oriented axis by means of a hinge arranged at a first end of the jaws.

The closure member comprises a pulling rod which is received in openings at the second free end of the jaws to pull the jaws toward one another. For example, a first end of the pulling rod is retained by a nut in the associated opening in one of the jaws.

To allow rapid actuation of the closure member, this comprises a cam lever. An articulation end of the cam lever is pivotably mounted on a second end of the pulling rod about an axially oriented pivot axis. The cam lever comprises, at its articulation end, a cam which is eccentric relative to the pivot axis. The pivot axis of the cam lever is received in an oblong aperture (not shown) in the jaw. The cam lever is thus mounted pivotably about the pivot axis and slidingly in a circumferential direction relative to the associated jaw. The associated jaw comprises a cam cradle, serving as fixed support against which the cam of the cam lever acts during closure.

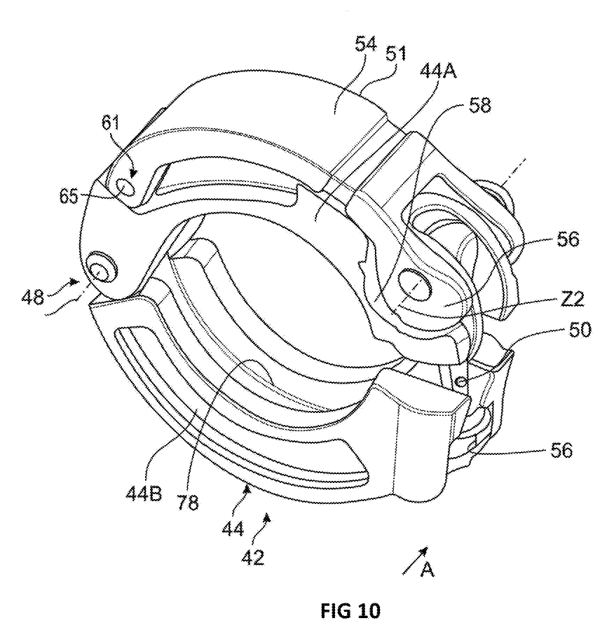

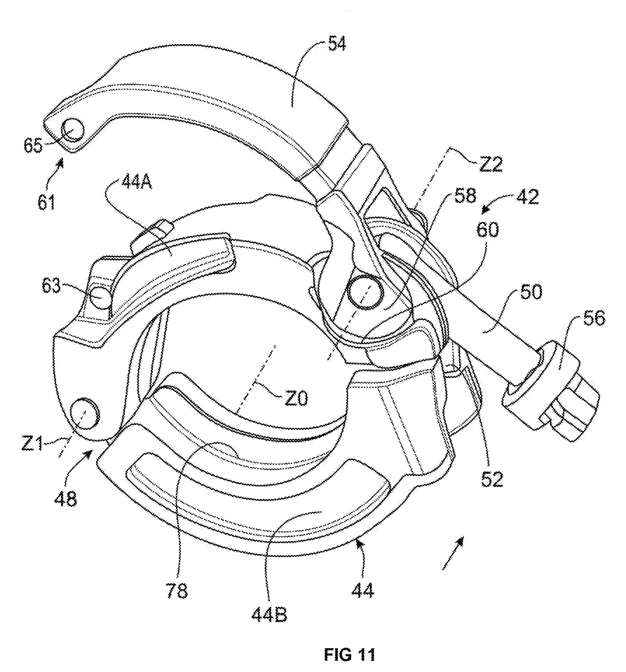

When the cam lever is in an open position, shown in FIG. 11, the cam is in an orientation in which it does not exert any pressure on the cradle, leaving the jaws unclamped. When the cam lever is pivoted into a closed position, shown in FIG. 10, the cam rotates and exerts increasing pressure on the cradle, clamping the jaws against one another.

Advantageously, the cam lever is equipped with a locking member for locking in the closed position, which makes it possible to prevent it from opening accidentally.

The locking member is in this case formed by a ball spring plunger which is in this case carried by the jaw and a ball of which is intended to be received elastically in a hole made at the free end of the cam lever, in the closed position. This thus makes it necessary to produce a force in order to be able to disengage the ball from the hole so as to pivot the cam lever into its open position.

As a variant, the locking member may be formed by an axial pin which is received in two holes belonging to the jaw and to the free end of the cam lever, respectively, the two holes coinciding in the closed position of the cam lever. It is thus necessary to remove the pin in order to pivot the cam lever into its open position.

The adjustment nut makes it possible to adjust the preload of the system in order to guarantee optimal clamping of the nozzle end-piece.

In a variant of the invention that has not been shown, the closure member may be replaced by a simple threaded screw having a screw head and receiving, at its opposite end, a tightening nut thus making it possible to obtain the desired clamping effect. Although such an embodiment does not allow a release as rapid as the embodiment shown in the figures, such an embodiment falls within the scope of the invention. Furthermore, attaching the nozzle end-piece by means of such a closure member is still faster than the attachment using axial screws according to the prior art.

According to another variant of the invention that has not been shown, the attachment member comprises two jaws which are completely independent of one another and are fastened together by two clamping/tightening screws. Although such an embodiment does not allow a release as rapid as the embodiment shown in the figures, such an embodiment falls within the scope of the invention. Furthermore, attaching the nozzle end-piece by means of such a closure member is still faster than the attachment using axial screws according to the prior art.

Whatever the embodiment selected for the clamping collar, the jaws, the nozzle end-piece and the support have elements making it possible to convert the radial clamping of the jaws around the nozzle end-piece into axial clamping of the nozzle end-piece against the support.

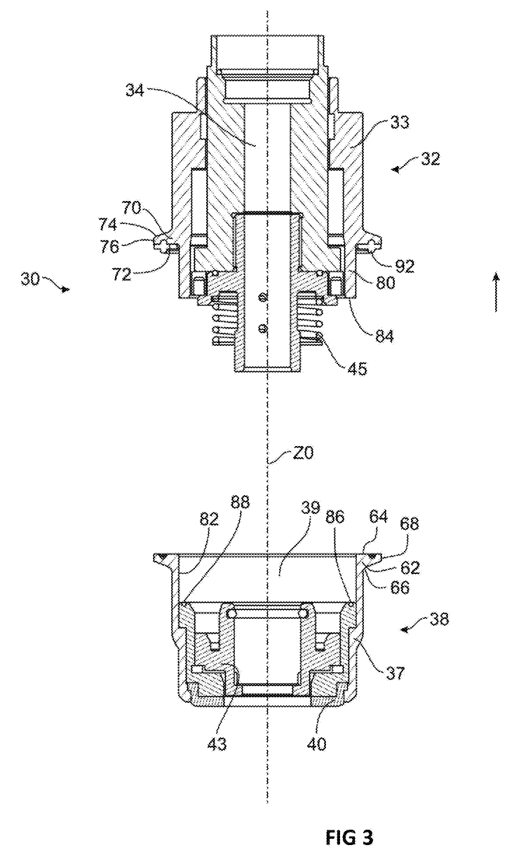

In order to allow axial clamping of the end-piece against the support, the nozzle end-piece comprises a first annular flange. The first annular flange extends radially protruding from the body of the nozzle end-piece. The first flange is in this case arranged at an upper end of the end-piece. The first flange has an upper bearing face which extends in a plane orthogonal to the axis of the nozzle. The bearing face is flat. The first flange also has a support face opposite its bearing face. The support face thus faces downward. The support face has a frustoconical shape. Thus, in axial section, as shown in FIGS. 3, 5 and 7, the support face is inclined with respect to the axis of the nozzle. The first flange is also delimited externally by a peripheral edge.

The support comprises a second annular flange. The second annular flange extends radially protruding from the body of the support. The second flange is in this case arranged close to a lower end of the support. The second flange has a lower bearing face which extends in a plane orthogonal to the axis of the nozzle. The bearing face is flat. The second flange also has a support face opposite its bearing face. The support face thus faces upward. The support face has a frustoconical shape. Thus, in axial section, as shown in FIGS. 3, 5 and 7, the support face is inclined with respect to the axis of the nozzle. The second flange is also delimited externally by a peripheral edge.

The two flanges have the same outside diameter. Thus, their peripheral edges are axially aligned when the end-piece is mounted on the support.

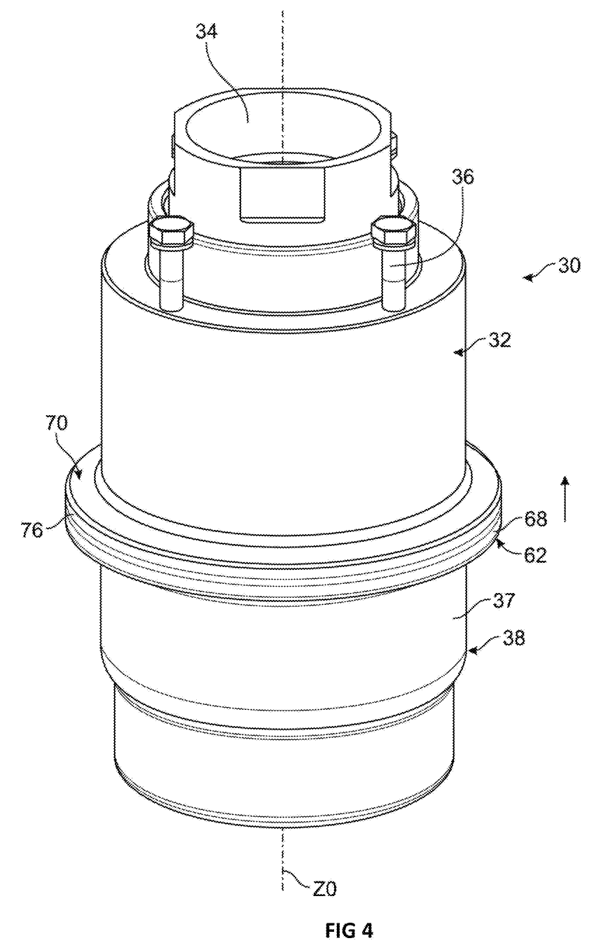

Furthermore, the flanges in this case have a shape which is symmetric about their joining plane orthogonal to the axis of the nozzle when the end-piece is mounted on the support, as shown in FIGS. 4 to 7.

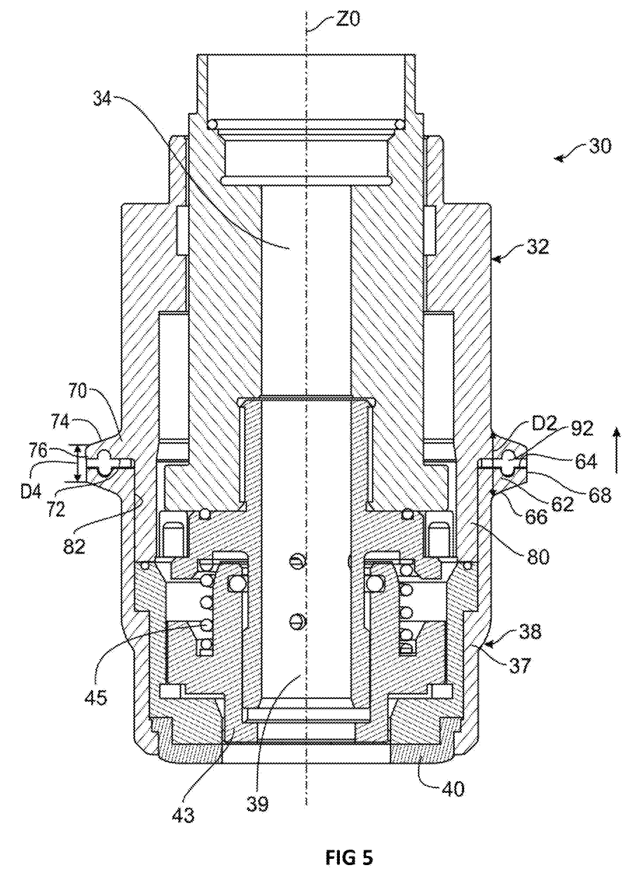

When the nozzle end-piece is mounted on the support, it is brought axially in line with the support, below the support as shown in FIGS. 2 and 3. The nozzle end-piece then bears axially against the support in such a way that the bearing face of the first flange is axially facing the opposite bearing face of the second annular flange, as shown in FIGS. 4 and 5.

The clamping collar of the attachment member is intended to radially clamp the edges of the two flanges, straddling them.

To facilitate positioning, and in particular centering, of the end-piece relative to the support, the support has a centering sleeve which extends axially protruding, in this case downward, from the bearing face of the second flange. As shown in FIG. 5, the centering sleeve is fitted axially in a central passage in the end-piece during mounting. The centering sleeve is received with a radial clearance just sufficient to allow it to slide in the central passage while ensuring good centering.

A free end of the centering sleeve is received in axial abutment against an internal shoulder of the end-piece. The shoulder is in this case carried by an annular piece which is received in a body of the end-piece and which is intended to be clamped axially between the body of the end-piece and the centering sleeve.

To ensure contact between the free end of the centering sleeve and the shoulder, an axial clearance is advantageously maintained between the bearing faces of the two flanges when the end-piece is mounted on the support.

A sealing gasket is advantageously provided between the free end of the centering sleeve and the shoulder to prevent the blowing air from escaping.

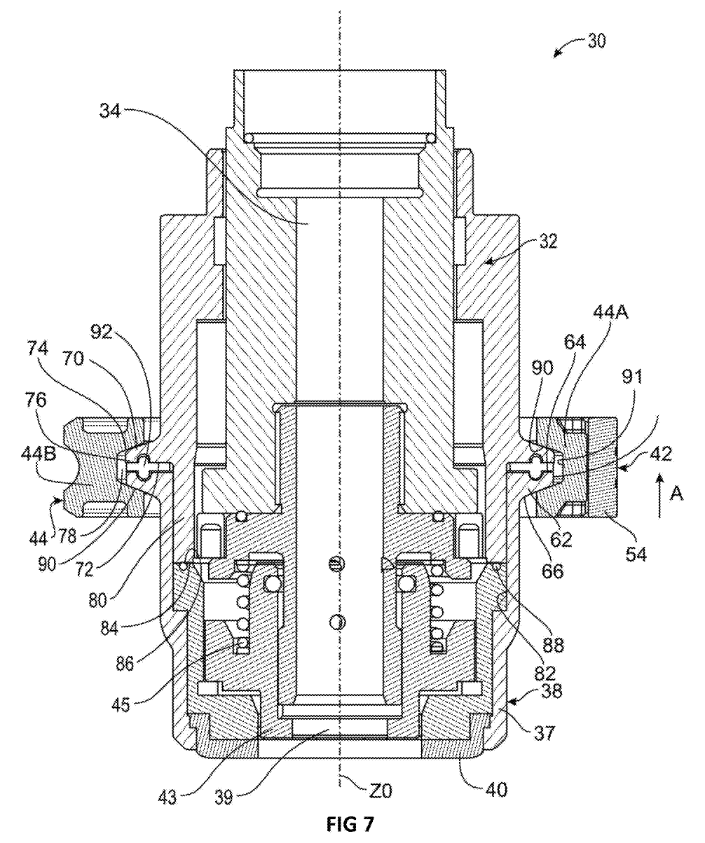

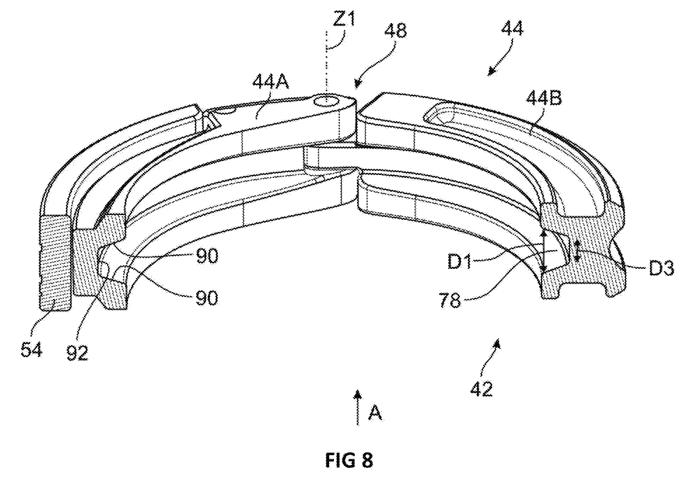

Furthermore, as shown in FIGS. 7 and 8, the clamping collar of the attachment member comprises an inner groove for receiving the two edges of the assembled flanges. The groove is made in an inner face of each of the jaws.

The inner groove is delimited axially by two inclined side walls diverging from the outside toward the inside. Each side wall has the same inclination as an associated support face.

The groove is thus delimited radially toward the outside by a bottom.

The collar is intended to be in contact with the support and the end-piece only via the side walls with the support faces.

To this end, it is preferable for a radial clearance to be maintained between the bottom of the groove and the flanges when the collar is clamped.

By way of non-limiting example, the axial dimension of the internal opening of the groove is smaller than the axial dimension of the overall axial thickness of the two flanges where they meet the body of the end-piece, in the case of the first flange, and the body of the support in the case of the second flange. Moreover, the axial dimension of the bottom of the groove is smaller than the axial dimension of the overall thickness of the edges of the two flanges.

Thus, each flange comprises a support face opposite its bearing face, each frustoconical support face interacting with an inclined side wall of the groove in order to axially compress the two bearing faces against one another when the jaws are clamped radially around the flanges.

To allow better attachment, provision is made to interpose a resilient annular pressure-responsive gasket between the two bearing faces before they are clamped. The pressure-responsive gasket is for example received in an annular slot in at least one of the two bearing faces. This makes it possible to obtain an additional clamping effect clamping the support faces against the side walls of the groove. This also makes it possible to equally distribute the axial clamping force clamping the end-piece against the support around the entire circumference of the flanges. It also makes it possible to ensure that there is proper contact between the end-piece and the support at the free end of the sleeve and the shoulder of the end-piece.

The invention thus allows optimal positioning of the end-piece on the support, which is obtained simply and inexpensively by virtue of the limited number of elements involved in this positioning.

Moreover, the use of such an attachment member makes it possible to quickly and easily replace an end-piece, which makes it possible to reduce the downtime of the manufacturing facility when there is a change in the size of the preforms being processed.

A number of implementations have been described. Nevertheless, it will be understood that various modifications may be made without departing from the spirit and scope of the disclosure. Accordingly, other implementations are within the scope of the following claims.

1. A nozzle for forming containers from thermoplastic material by injecting a pressurized fluid into a preform, the nozzle comprising:
a support equipped with a pressurized fluid intake pipe;
a tubular nozzle end-piece, separate from the support, which is intended to be mounted on the support to extend the intake pipe and which comprises a blowing seal for sealingly connecting its free end to a preform;
an attachment member for removably attaching the end-piece to the support;
wherein the attachment member comprises a clamping collar.

2. The nozzle as claimed in claim 1, wherein the nozzle end-piece comprises a first annular flange and the support comprises a second annular flange, a bearing face of which is intended to come into axial abutment against a facing bearing face of the first annular flange when the nozzle end-piece is mounted on the support, the clamping collar clamping edges of the two flanges.

3. The nozzle as claimed in claim 2, wherein the clamping collar comprises an inner groove for receiving the assembled flanges.

4. The nozzle as claimed in claim 3, wherein each flange comprises a support face opposite its bearing face, the support face having a frustoconical shape interacting with an inclined side wall of the groove in order to axially compress the two bearing faces against one another when the collar is clamped radially around the flanges.

5. The nozzle as claimed in claim 4, wherein a resilient annular pressure-responsive gasket is interposed between the two bearing faces.

6. The nozzle as claimed in claim 5, wherein the pressure-responsive gasket is received in an annular slot in at least one of the two bearing faces.

7. The nozzle as claimed in claim 2, wherein the support has a centering sleeve which extends axially protruding from the bearing face of the second flange, the centering sleeve being fitted axially in a central passage in the end-piece during mounting.

8. The nozzle as claimed in claim 7, wherein a free end of the centering sleeve is received in axial abutment against an internal shoulder of the end-piece.

9. The nozzle as claimed in claim 8, wherein an annular sealing gasket is interposed between the shoulder and the free end of the sleeve when the end-piece is mounted on the support.

10. The nozzle as claimed in claim 1, wherein the clamping collar comprises at least two jaws clamped against one another by at least one closure member.

11. The nozzle as claimed in claim 10, wherein the jaws are articulated to one another by a hinge arranged at a first end of the jaws, the closure member being arranged at the other end of the jaws.

12. The nozzle as claimed in claim 11, wherein the at least one closure member comprises a pulling rod which is received in openings at the free ends of the jaws to pull the jaws toward one another.

13. The nozzle as claimed in claim 12, wherein the attachment member comprises a cam lever which pulls the rod when it is folded down against the jaw.

14. A nozzle end-piece having a main axis, for a nozzle for forming containers from thermoplastic material, the nozzle end-piece comprising:
a blowing seal for sealingly connecting its free end to a preform;
a first annular flange arranged at an upper end of the end-piece and having a bearing face and an opposite support face, the support face having a frustoconical shape whereas the bearing face is orthogonal to the axis.

15. The nozzle end-piece as claimed in claim 14, further comprising a stabilizer intended to bear on a rim of the preform to prevent the preform from moving inside a mold.

16. The nozzle end-piece as claimed in claim 14, further comprising an internal shoulder configured to receive a free end of a centering sleeve in axial abutment.

17. A nozzle support having a main axis, for a nozzle for forming containers from thermoplastic material, the nozzle support comprising:
a second annular flange having a bearing face and an opposite support face, the support face having a frustoconical shape whereas the bearing face is orthogonal to the axis;
a centering sleeve which extends axially protruding from the bearing face of the second flange.

18. The nozzle support as claimed in claim 17, further comprising a pressurized fluid intake pipe which passes through a body of the support axially.

19. The nozzle support as claimed in claim 17, wherein the second annular flange has an outside diameter configured to align with a peripheral edge of a first annular flange of a nozzle end-piece when the end-piece is mounted on the support.

20. The nozzle support as claimed in claim 17, wherein the centering sleeve is configured to be received with a radial clearance in a central passage of a nozzle end-piece to allow sliding while ensuring centering.
